(19) United States
(12) Patent Application Publication
(10) Pub. No.: US 2021/0178662 A1
(43) Pub. Date: Jun. 17, 2021

(54) Three-Dimensional Printing System Employing A Fiber-Reinforced Polymer Composition

(71) Applicant: Ticona LLC, Florence, KY (US)

(72) Inventors: Craig J. Peterson, Hebron, KY (US); David W. Eastep, Winona, MN (US)

(21) Appl. No.: 17/120,374

(22) Filed: Dec. 14, 2020

Related U.S. Application Data
(60) Provisional application No. 62/948,879, filed on Dec. 17, 2019.

(51) Int. Cl. B29C 64/118; B29C 64/209; B29C 64/255; B29C 64/329

(52) U.S. Cl. CPC B29C 64/118; B29C 64/209; B33Y 10/00; B29C 64/329; B29C 64/255

(57) ABSTRACT

A three-dimensional printing method is provided. The method comprises supplying a polymer composition to an extruder system and selectively dispensing the polymer composition through an extruder nozzle to form a three-dimensional structure. The polymer composition comprises a plurality of reinforcing fibers embedded and distributed within a thermoplastic polymer matrix, wherein the thermoplastic polymer matrix constitutes from about 20 wt. % to about 90 wt. % of the composition and the reinforcing fibers constitute from about 10 wt. % to about 80 wt. % of the composition.

### RELATED APPLICATION

The present application claims priority to U.S. Provisional Application Ser. No. 62/948,879, filed on Dec. 17, 2019, which is incorporated herein in its entirety by reference thereto.

### BACKGROUND OF THE INVENTION

Additive manufacturing, also called three-dimensional or 3D printing, is generally a process in which a three-dimensional structure is selectively formed from a digital model. Various types of three-dimensional printing techniques may be employed, such as fused deposition modeling, ink jetting, powder bed fusion (e.g., selective laser sintering), powder/binder jetting, electron-beam melting, electrophotographic imaging, and so forth. In a fused deposition modeling system, for instance, a build material may be extruded through an extrusion tip carried by a print nozzle of the system, and then deposited as a sequence of layers on a substrate. The extruded material fuses to previously deposited material, and solidifies upon a drop in temperature. The position of the print nozzle relative to the substrate may be incremented along an axis (perpendicular to the build plane) after each layer is formed, and the process may then be repeated to form a printed part resembling the digital representation. If desired, supporting layers or structures can also be built underneath overhanging portions or in cavities of printed parts under construction, which are not supported by the build material itself. The support structure adheres to the part material during fabrication, and is removable from the completed printed part when the printing process is complete. Unfortunately, one problem with many conventional techniques is that the materials employed generally lack the requisite mechanical properties to be used in advanced product applications. Furthermore, attempts at increasing strength can make it difficult to process the materials in a three-dimensional printing process. As such, a need exists for a polymer composition that can be readily employed in a three-dimensional printing system.

### SUMMARY OF THE INVENTION

In accordance with one embodiment of the present invention, a three-dimensional printing method is disclosed that comprises supplying a polymer composition to an extruder system and selectively dispensing the polymer composition through an extruder nozzle of the system to form a three-dimensional structure. The polymer composition comprises a plurality of reinforcing fibers embedded and distributed within a thermoplastic polymer matrix, wherein the thermoplastic polymer matrix constitutes from about 20 wt. % to about 90 wt. % of the composition and the reinforcing fibers constitute from about 10 wt. % to about 80 wt. % of the composition. In accordance with another embodiment of the present invention, a printer cartridge for use in a three-dimensional printing system is disclosed that comprises a filament that is formed from a polymer composition, such as described above. In accordance with yet another embodiment of the present invention, a three-dimensional printing system is disclosed that comprises a supply source containing a polymer composition, such as described above, and a nozzle that is configured to receive the polymer composition from the supply source and deposit the composition onto a substrate.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a front view of one embodiment of a fused deposition modeling system that may be employed in the present invention;

FIG. 2 is a perspective view of one embodiment of a three-dimensional structure that may be formed from the polymer composition of the present invention;

FIGS. 3A-3C are cross-sectional views of FIG. 2 taken along a line 3A-3A, depicting a process for forming a three-dimensional structure;

FIG. 4 is an exploded perspective view of one embodiment of a printer cartridge that may be employed in the present invention;

FIG. 5 is a schematic illustration of one embodiment of a system that may be used to form the fiber-reinforced polymer composition of the present invention; and

FIG. 6 is a cross-sectional view of an impregnation die that may be employed in the system shown in FIG. 5.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a three-dimensional printing system and method that employs a polymer composition (e.g., tape, sheet, filament, pellets, etc.) that contains a plurality of reinforcing fibers embedded and distributed within a thermoplastic polymer matrix. By selectively controlling the specific nature of the fibers, polymer, and other aspects of the composition, the present inventors have discovered that the resulting composition can achieve certain unique properties that enable the composition to be readily employed in a three-dimensional printing system. More particularly, the reinforcing fibers may constitute from about 10 wt. % to about 80 wt. %, in some embodiments from about 15 wt. % to about 65 wt. %, and in some embodiments, from about 20 wt. % to about 50 wt. % of the composition. Likewise, the polymer matrix typically constitutes from about 20 wt. % to about 90 wt. %, in some embodiments from about 35 wt. % to about 85 wt. %, and in some embodiments, from about 50 wt. % to about 80 wt. % of the composition.

Through selective control over the particular nature and concentration of each of these components, as well as the manner in which the fibers are impregnated into the polymer matrix, the present inventors have discovered that the resulting composition can excellent properties for use in three-dimensional printing systems. For example, the composition may exhibit a tensile strength of from about 20 to about 300 MPa, in some embodiments from about 30 to about 200 MPa, and in some embodiments, from about 40 to about 150 MPa; a tensile break strain of about 0.5% or more, in some embodiments from about 0.6% to about 5%, and in some embodiments, from about 0.7% to about 2.5%; and/or a tensile modulus of from about 3,500 MPa to about 20,000 MPa, in some embodiments from about 4,000 MPa to about 15,000 MPa, and in some embodiments, from about 5,000 MPa to about 10,000 MPa. The tensile properties may be determined in accordance with ISO Test No. 527-1:2012 (technically equivalent to ASTM D638-14) at −30° C., 23° C., or 80° C. The composition may also exhibit a flexural strength of from about 50 to about 500 MPa, in some embodiments from about 80 to about 400 MPa, and in some embodiments, from about 100 to about 250 MPa and/or a flexural modulus of from about 2000 MPa to about 20,000 MPa, in some embodiments from about 3,000 MPa to about 15,000 MPa, and in some embodiments, from about 4,000 MPa to about 10,000 MPa. The flexural properties may be determined in accordance with ISO Test No. 178:2010 (technically equivalent to ASTM D790-15e2) at −30° C., 23° C., or 80° C.

The fiber-reinforced composition may not be highly sensitive to aging at high temperatures. For example, when aged in an atmosphere having a temperature of from about 100° C. or more, in some embodiments from about 120° C. to about 200° C., and in some embodiments, from about 130° C. to about 180° C. (e.g., 150° C.) fora time period of about 100 hours or more, in some embodiments from about 300 hours to about 3000 hours, and in some embodiments, from about 400 hours to about 2500 hours (e.g., about 1,000 hours), the mechanical properties (e.g., tensile properties and/or flexural properties) may still remain within the ranges noted above. For example, the ratio of a particular mechanical property (e.g., flexural strength) after “aging” at 150° C. for 1,000 hours to the initial mechanical property prior to such aging may be about 0.6 or more, in some embodiments about 0.7 or more, and in some embodiments, from about 0.8 to 1.0. In one embodiment, for example, a thin part (e.g., 1.2 mm in thickness) may exhibit a flexural strength after being aged at a high temperature atmosphere (e.g., 150° C.) for 1,000 hours of about 50 to about 500 MPa, in some embodiments from about 80 to about 400 MPa, and in some embodiments, from about 100 to about 250 MPa, measured according to ISO Test No. 178:2010 at a temperature of 23° C. (technically equivalent to ASTM D790-15e2). Likewise, the thin part (e.g., 1.2 mm in thickness) may also exhibit a tensile strength after being aged at a high temperature atmosphere (e.g., 150° C.) for 1,000 hours of from about 20 to about 300 MPa, in some embodiments from about 30 to about 200 MPa, and in some embodiments, from about 40 to about 150 MPa as determined at a temperature of 23° C. in accordance with ISO Test No. 527-1:2012 (technically equivalent to ASTM D638-14).

The composition may also exhibit low emissions of volatile organic compounds. As used herein, the term “volatile compounds” or “volatiles” generally refer to organic compounds that have a relatively high vapor pressure. For example, the boiling point of such compounds at atmospheric pressure (1 atmosphere) may be about 80° C. or less, in some embodiments about 70° C. or less, and in some embodiments, from about 0° C. to about 60° C. One example of such a compound is 2-methyl-1-propene. The resulting composition can exhibit low volatile emissions through selective control over the nature of the materials employed in the polymer composition and the particular manner in which they are combined together. For example, the fiber-reinforced composition may exhibit a total volatile content (“VOC”) of about 100 micrograms equivalent carbon per gram of the composition (“μgC/g”) or less, in some embodiments about 70 μg/g or less, in some embodiments about 50 μg/g or less, and in some embodiments, about 40 μg/g or less, as determined in accordance with VDA 277:1995. The composition may also exhibit a toluene equivalent volatile content (“TVOC”) of about 250 micrograms equivalent toluene per gram of the composition (“μg/g”) or less, in some embodiments about 150 μg/g or less, and in some embodiments, about 100 μg/g or less, as well as a fogging content (“FOG”) of about 500 micrograms hexadecane per gram of the composition (“μg/g”) or less, in some embodiments about 350 μg/g or less, and in some embodiments, about 300 μg/g or less, each of which may be determined in accordance with VDA 278:2002.

Various embodiments of the present invention will now be described in more detail.

### I. Polymer Composition

A. Polymer Matrix

The polymer matrix generally functions as a continuous phase of the composition and may contain any of a variety of thermoplastic polymers. For example, the thermoplastic polymer may be an aliphatic polymer, such as a polyolefin (e.g., ethylene polymer, propylene polymer, etc.), polyamide, polyacetal (e.g., polyoxymethylene), polyurethane, etc., as well as combinations thereof. In one embodiment, for instance, the polymer matrix may contain one or more propylene polymers. Any of a variety of propylene polymers or combinations of propylene polymers may generally be employed, such as propylene homopolymers (e.g., syndiotactic, atactic, isotactic, etc.), propylene copolymers (e.g., block copolymer, random copolymer, heterophase copolymers, etc.), and so forth. In one embodiment, for instance, a propylene polymer may be employed that is an isotactic or syndiotactic homopolymer. The term “syndiotactic” generally refers to a tacticity in which a substantial portion, if not all, of the methyl groups alternate on opposite sides along the polymer chain. On the other hand, the term “isotactic” generally refers to a tacticity in which a substantial portion, if not all, of the methyl groups are on the same side along the polymer chain. Such homopolymers may have a melting point of from about 160° C. to about 170° C. In yet other embodiments, a copolymer of propylene with an α-olefin monomer may be employed. Specific examples of suitable α-olefin monomers may include ethylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Ethylene is particularly suitable. The overall propylene content of such copolymers may be from about 60 wt. % to about 99 wt. %, in some embodiments from about 70 wt. % to about 97 wt. %, and in some embodiments, from about 80 wt. % to about 95 wt. %. Likewise, the overall α-olefin content may likewise range from about 1 wt. % to about 40 wt. %, in some embodiments from about 3 wt. % to about 30 wt. %, and in some embodiments, from about 5 wt. % to about 20 wt. %.

In certain embodiments, the propylene polymer may be a heterophase copolymer that is formed from at least two components—i.e., a matrix phase and dispersed phase. The matrix phase typically includes an isotactic propylene homopolymer, though an α-olefin comonomer may be used in relatively small amounts, such as about 10 wt. % or less, in some embodiments about 6 wt. % or less, and in some embodiments, about 4 wt. % or less. While by no means required, the inclusion of a small amount of comonomer may result in a product with lower stiffness but with higher impact strength. Regardless of the particular polymer employed, the matrix phase typically has a low xylene solubles content, such as about 3 wt. % or less, in some embodiments about 2 wt. % or less, and in some embodiments, about 1.5 wt. % or less. The dispersed phase typically includes a propylene/α-olefin copolymer such as described above (e.g., propylene/ethylene copolymer). In the dispersed phase, the α-olefin content is generally present at a higher level than the overall content of the copolymer as noted above. For instance, the α-olefin content of the dispersed phase may be from about 40 wt. % to about 90 wt. %, in some embodiments from about 45 wt. % to about 85 wt. %, and in some embodiments, from about 50 wt. % to about 80 wt. %. Likewise, the propylene content of the dispersed phase may range from about 10 wt. % to about 60 wt. %, in some embodiments from about 15 wt. % to about 55 wt. %, and in some embodiments, from about 20 wt. % to about 50 wt. %. While such heterophase copolymers can be produced by melt compounding the individual polymer components, it is typically desired that they are made in a reactor. This is conveniently accomplished by polymerizing propylene in a first reactor and transferring the high crystalline propylene homopolymer from the first reactor into a secondary reactor where propylene and the α-olefin monomer (e.g., ethylene) are copolymerized in the presence of the homopolymer. Any of a variety of known catalyst systems may generally be employed to form the propylene polymers. For instance, the polymers may be formed using a free radical or a coordination catalyst (e.g., Ziegler-Natta) or a single-site coordination catalyst (e.g., metallocene catalyst).

The propylene polymer may have a melt flow index of from about 20 to about 300 grams per 10 minutes or more, in some embodiments from about 50 to about 250 grams per 10 minutes or less, and in some embodiments, from about 80 to about 160 grams per 10 minutes, as determined in accordance with ISO 1133-1:2011 (technically equivalent to ASTM D1238-13) at a load of 2.16 kg and temperature of 230° C. Further, the propylene polymer may also exhibit a high degree of impact resistance. In this regard, the polymer may exhibit an Izod notched impact strength of greater than about 20 kJ/m², in some embodiments from about 30 to about 100 kJ/m², and in some embodiments, from about 40 to about 80 kJ/m², measured at 23° C. according to ISO Test No. 180:2000 (technically equivalent to ASTM D256-10e1). Notably, the polymer may retain a substantial portion of this strength even at extreme temperatures. For example, the ratio of the Izod notched impact strength at −20° C. to the impact strength at 23° C. may be about 0.6 or more, in some embodiments about 0.6 or more, and in some embodiments, from about 0.7 to 1.0. In one embodiment, for example, the propylene polymer may exhibit an Izod notched impact strength at −20° C. of greater than about 15 kJ/m², in some embodiments from about 20 to about 80 kJ/m², and in some embodiments, from about 30 to about 50 kJ/m², measured at 23° C. according to ISO Test No. 180:2000 (technically equivalent to ASTM D256-10e1).

Of course, beside aliphatic polymers, semi-aromatic and/or aromatic thermoplastic polymers may also be employed in the polymer matrix. Examples of such polymers may include, for instance, polyamides (e.g., semi-aromatic and/or aromatic polyamides), polyesters (e.g., polyethylene terephthalate, polybutylene terephthalate, etc.), polyarylene sulfides, polyarylketones (e.g., polyetheretherketone, polyetherketoneketone, etc.), polyurethanes, etc., as well as blends thereof. Particularly suitable aromatic polymers are high performance polymers that have a relatively high glass transition temperature and/or high melting temperature. Such high performance polymers can thus provide a substantial degree of heat resistance to the polymer composition. For example, the polymer may have a glass transition temperature of about 30° C. or more, in some embodiments about 40° C. or more, in some embodiments from about 50° C. to about 250° C., in some embodiments from about 60° C. to about 150° C. The polymer may also have a melting temperature of about 180° C. or more, in some embodiments about 200° C. or more, in some embodiments from about 210° C. to about 400° C., in some embodiments from about 220° C. to about 380° C. The glass transition and melting temperatures may be determined as is well known in the art using differential scanning calorimetry (“DSC”), such as determined by ISO Test No. 11357-2:2013 (glass transition) and 11357-3:2011 (melting).

Polyarylene sulfides are suitable semi-crystalline aromatic polymers having the characteristics noted above. The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

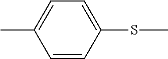

and segments having the structure of formula:

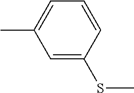

or segments having the structure of formula:

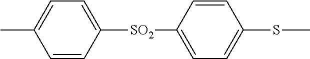

The polyarylene sulfide may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

Another example of a suitable aromatic polymer is an aromatic polyamide, which may have a relatively high melting temperature, such as about 200° C. or more, in some embodiments about 220° C. or more, and in some embodiments from about 240° C. to about 320° C., as determined using differential scanning calorimetry according to ISO Test No. 11357. The glass transition temperature of the aromatic polyamides is likewise generally from about 110° C. to about 160° C. Aromatic polyamides typically contain repeating units held together by amide linkages (NH—CO) and are synthesized through the polycondensation of dicarboxylic acids (e.g., aromatic dicarboxylic acids), diamines (e.g., aliphatic diamines), etc. For example, the aromatic polyamide may contain aromatic repeating units derived from an aromatic dicarboxylic acid, such as terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc., as well as combinations thereof. Terephthalic acid is particularly suitable. Of course, it should also be understood that other types of acid units may also be employed, such as aliphatic dicarboxylic acid units, polyfunctional carboxylic acid units, etc. The polyamide may also contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Repeating units derived from 1,9-nonanediamine and/or 2-methyl-1,8-octanediamine are particularly suitable. Of course, other diamine units may also be employed, such as alicyclic diamines, aromatic diamines, etc.

Particularly suitable aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA 10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephlhalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene lerephthalamide/dodecamelhylene dodecanediarnide) (PA12T/1212), poly(dodecamethylene terephthalamide/caprolactam) (PA12T/6), poly(dodecamethylene terephthalamide/hexamethylene hexanediamide) (PA12T/66), polyphthalamide (PPA), and so forth. Particularly suitable aliphatic polyamides may include polyamide 4,6, polyamide 5,10, polyamide 6, polyamide 6,6, polyamide 6,9, polyamide 6,10, polyamide 6,12, polyamide 11, polyamide 12, and so forth. Yet other examples of suitable aromatic polyamides are described in U.S. Pat. No. 8,324,307 to Harder, et al.

Another suitable semi-crystalline aromatic polymer that may be employed in the present invention is a polyaryletherketone. Polyaryletherketones are semi-crystalline polymers with a relatively high melting temperature, such as from about 300° C. to about 400° C., in some embodiments from about 310° C. to about 390° C., and in some embodiments from about 330° C. to about 380° C. The glass transition temperature may likewise be from about 110° C. to about 200° C. Particularly suitable polyaryletherketones are those that primarily include phenyl moieties in conjunction with ketone and/or ether moieties. Examples of such polymers include polyetheretherketone (“PEEK”), polyetherketone (“PEK”), polyetherketoneketone (“PEKK”), polyetherketoneetherketoneketone (“PEKEKK”), polyetheretherketoneketone (“PEEKK”), polyether-diphenyl-ether-ether-diphenyl-ether-phenyl-ketone-phenyl, etc., as well as blends and copolymers thereof.

B. Reinforcing Fibers

To form the fiber-reinforced composition, reinforcing fibers are generally embedded within the polymer matrix. The fibers may generally be long fiber and/or continuous fibers. The term “continuous fibers” generally refers to fibers that have a length that is the same or substantially similar to the part into which it is formed. The term “long fibers” generally refers to fibers, filaments, yarns, or rovings (e.g., bundles of fibers) that are not continuous and have a length that is typically from about 1 to about 25 millimeters, in some embodiments, from about 1.5 to about 20 millimeters, in some embodiments from about 2 to about 15 millimeters, and in some embodiments, from about 3 to about 12 millimeters. Due to the unique properties of the composition, a substantial portion of the long fibers may maintain a relatively large length even after being three-dimensionally printed into the shape of a part.

The reinforcing fibers may be formed from any conventional material known in the art, such as metal fibers; glass fibers (e.g., E-glass, A-glass, C-glass, D-glass, AR-glass, R-glass, S1-glass, S2-glass), carbon fibers (e.g., graphite), boron fibers, ceramic fibers (e.g., alumina or silica), aramid fibers (e.g., Kevlar®), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing thermoplastic compositions. Glass fibers and carbon fibers are particularly desirable. Such fibers often have a nominal diameter of about 4 to about 35 micrometers, and in some embodiments, from about 9 to about 35 micrometers. The fibers may be twisted or straight. If desired, the fibers may be in the form of rovings (e.g., bundle of fibers) that contain a single fiber type or different types of fibers. Different fibers may be contained in individual rovings or, alternatively, each roving may contain a different fiber type. For example, in one embodiment, certain rovings may contain carbon fibers, while other rovings may contain glass fibers. The number of fibers contained in each roving can be constant or vary from roving to roving. Typically, a roving may contain from about 1,000 fibers to about 50,000 individual fibers, and in some embodiments, from about 2,000 to about 40,000 fibers.

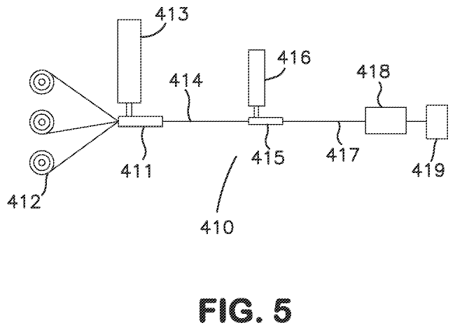

Any of a variety of different techniques may generally be employed to incorporate the fibers into the polymer matrix. The fibers may be randomly distributed within the polymer matrix, or alternatively distributed in an aligned fashion. In one embodiment, for instance, continuous fibers may initially be impregnated into the polymer matrix to form an extrudate. In such embodiments, the polymer matrix and continuous fibers (e.g., rovings) are typically pultruded through an impregnation die to achieve the desired contact between the fibers and the polymer. Pultrusion can also help ensure that the fibers are spaced apart and oriented in a longitudinal direction that is parallel to a major axis of the pellet (e.g., length), which further enhances the mechanical properties. Referring to FIG. 5, for instance, one embodiment of a pultrusion process 410 is shown in which a polymer matrix is supplied from an extruder 413 to an impregnation die 411 while continuous fibers 412 are a pulled through the die 411 via a puller device 418 to produce a composite structure 414. Typical puller devices may include, for example, caterpillar pullers and reciprocating pullers. While optional, the composite structure 414 may also be pulled through a coating die 415 that is attached to an extruder 416 through which a coating resin is applied to form a coated structure 417.

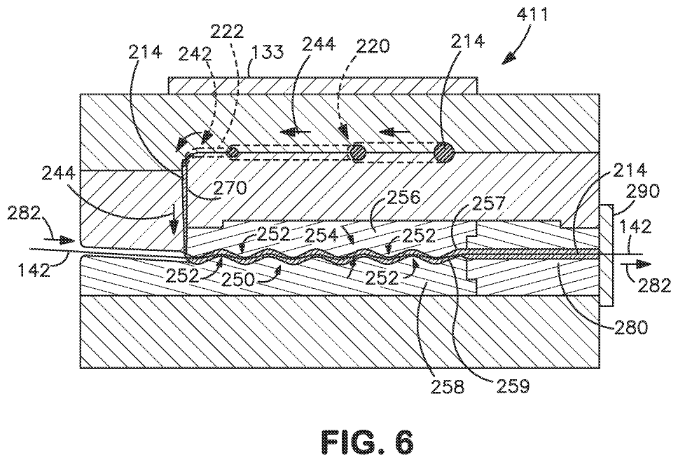

Regardless, the nature of the impregnation die employed during the pultrusion process may be selectively varied to help achieved good contact between the polymer matrix and the reinforcing fibers. Examples of suitable impregnation die systems are described in detail in Reissue Pat. No. 32,772 to Hawley; U.S. Pat. No. 9,233,486 to Regan, et al.; and U.S. Pat. No. 9,278,472 to Easter), et al. Referring to FIG. 6, for instance, one embodiment of such a suitable impregnation die 411 is shown. As shown, a polymer matrix 214 may be supplied to the impregnation die 411 via an extruder (not shown) and optionally heated inside the die by a heater 133. The die is generally operated at temperatures that are sufficient to cause and/or maintain the proper melt temperature for the polymer, thus allowing for the desired level of impregnation of the rovings by the polymer. The polymer matrix 214 flows into the die 411 as indicated by resin flow direction 244. The polymer matrix 214 is distributed within the die 411 and then interacts with fibers 142 (e.g., fiber rovings), which are traversed through the die 411 in roving run direction 282 and coated with the polymer matrix 214.

The impregnation die 411 may also include a manifold assembly 220 and an impregnation section. Within the impregnation section, it is generally desired that the fibers 142 are traversed through an impregnation zone 250 to impregnate the rovings with the polymer matrix 214. The impregnation zone 250 may be defined between two spaced apart opposing impregnation plates 256 and 258. First plate 256 defines a first inner surface 257, while second plate 258 defines a second inner surface 259. The contact surfaces 252 may be defined on or extend from both the first and second inner surfaces 257 and 259, or only one of the first and second inner surfaces 257 and 259. Angle 254 at which the fibers 142 traverse the contact surfaces 252 may be generally high enough to enhance shear and pressure, but not so high to cause excessive forces that will break the fibers. Thus, for example, the angle 254 may be in the range between approximately 1° and approximately 30°, and in some embodiments, between approximately 5° and approximately 25°. Within the impregnation zone 250, the polymer matrix may be forced generally transversely through the rovings by shear and pressure created in the impregnation zone 250, which significantly enhances the degree of impregnation. Typically, the die 411 will include a plurality of contact surfaces 252, such as for example at least 2, at least 3, from 4 to 7, from 2 to 20, from 2 to 30, from 2 to 40, from 2 to 50, or more contact surfaces 252, to create a sufficient degree of penetration and pressure on the fibers 142. The impregnation section may also include one or more channels 222 through which the polymer matrix 214 can flow. After flowing through the manifold assembly 220, the polymer matrix 214 may flow through a gate passage 270 and the impregnated fibers 142 may exit through outlet region 242. If desired, a land zone 280 may be positioned downstream of the impregnation zone 250 in run direction 282 of the fibers 142. The fibers 142 may traverse through the land zone 280 before exiting the die 150. Further, a faceplate 290 may adjoin or be adjacent to the impregnation zone 250 to meter excess polymer 214 from the fibers 142. The faceplate 290 may be positioned downstream of the impregnation zone 250 and, if included, the land zone 280, in the run direction 282. The faceplate 290 may contact other components of the die 411, such as the impregnation zone 250 or land zone 280, or may be spaced therefrom.

To further facilitate impregnation, the fibers may be kept under tension while present within the impregnation die. The tension may, for example, range from about 5 to about 300 Newtons, in some embodiments from about 50 to about 250 Newtons, and in some embodiments, from about 100 to about 200 Newtons per tow of fibers. Furthermore, the fibers may also pass impingement zones in a tortuous path to enhance shear. For example, in the embodiment shown in FIG. 6, the fibers traverse over the impingement zones in a sinusoidal-type pathway.

The impregnation die shown and described above is but one of various possible configurations that may be employed in the present invention. In alternative embodiments, for example, the fibers may be introduced into a crosshead die that is positioned at an angle relative to the direction of flow of the polymer melt. As the fibers move through the crosshead die and reach the point where the polymer exits from an extruder barrel, the polymer is forced into contact with the fibers. It should also be understood that any other extruder design may also be employed, such as a twin screw extruder. Still further, other components may also be optionally employed to assist in the impregnation of the fibers. For example, a “gas jet” assembly may be employed in certain embodiments to help uniformly spread a bundle or tow of individual fibers, which may each contain up to as many as 24,000 fibers, across the entire width of the merged tow. This helps achieve uniform distribution of strength properties in the ribbon. Such an assembly may include a supply of compressed air or another gas that impinges in a generally perpendicular fashion on the moving fiber tows that pass across the exit ports. The spread fiber bundles may then be introduced into a die for impregnation, such as described above.

After impregnation, the resulting polymer composition may have a variety of different forms, such as a tape, sheet, filament, pellet, etc. For example, when it is desired to employ continuous fibers as the reinforcing fibers, the polymer composition may be desirably provided in the form of a tape or sheet. In FIG. 5, for example, the coated structure 417 may be in the form of a tape that can be supplied as a source in a three-dimensional printing process. The tape may include a “polymer-rich” portion having a greater volume of the polymer than fibers and a “fiber-rich” portion having a greater volume of fibers than polymer. The “polymer-rich” portion may, for instance, contain about 50% or more, in some embodiments about 70% or more, and in some embodiments, from about 80% to 100% by volume of the polymer matrix, and about 50% or less, in some embodiments about 30% or less, and in some embodiments, from 0% to about 20% by volume of the reinforcing fibers. Conversely, the “fiber-rich” portion may contain about 50% or more, in some embodiments about 70% or more, and in some embodiments, from about 80% to 100% by volume of the reinforcing fibers, and about 50% or less, in some embodiments about 30% or less, and in some embodiments, from 0% to about 20% by volume of the polymer matrix. Typically, the polymer-rich portion is located at the outer surface of the tape. For example, when viewed in cross-section, the tape may define an upper outer surface and opposing lower outer surface. An upper region is location adjacent to the upper outer surface, lower region is positioned adjacent to the lower outer surface, and a central region is positioned between the upper and lower regions. In certain embodiments, the central region may be a fiber-rich portion, and the upper and/or lower regions may be polymer-rich portions.

Alternatively, when it is desired to employ long fibers, the polymer composition may be initially formed into pellets. In FIG. 5, for example, the coated structure 417 may be supplied to a pelletizer 419 that cuts the structure 417 into pellets. The pellets may be supplied directly to three-dimensional printing process or alternatively formed into a different shape (e.g., filament, tape, sheet, etc.), which is then supplied to the three-dimensional printing process.

Regardless of its particular form, the resulting polymer composition may exhibit a very low void fraction, which helps enhance strength. For instance, the void fraction may be about 5% or less, in some embodiments about 3% or less, in some embodiments about 2% or less, in some embodiments about 1.5% or less, in some embodiments about 1% or less, and in some embodiments, about 0.5% or less. The void fraction may be measured using techniques well known to those skilled in the art. For example, the void fraction may be measured using a “resin burn off” test in which samples are placed in an oven (e.g., at 600° C. for 3 hours) to burn out the resin. The mass of the remaining fibers may then be measured to calculate the weight and volume fractions. Such “burn off” testing may be performed in accordance with ASTM D 2584-18 to determine the weights of the fibers and the polymer matrix, which may then be used to calculate the “void fraction” based on the following equations:

V_{f}=100*(ρₜ−ρ_{c})/ρₜ

where,

V_{f} is the void fraction as a percentage;

ρ_{c} is the density of the composite as measured using known techniques, such as with a liquid or gas pycnometer (e.g., helium pycnometer);

ρₜ is the theoretical density of the composite as is determined by the following equation:

ρₜ=1/[W_{f}/ρ_{f}+Wₘ/ρₘ]

ρₘ is the density of the polymer matrix (e.g., at the appropriate crystallinity);

β_{f} is the density of the fibers;

W_{f} is the weight fraction of the fibers; and

Wₘ is the weight fraction of the polymer matrix.

Alternatively, the void fraction may be determined by chemically dissolving the resin in accordance with ASTM D 3171-15. The “burn off” and “dissolution” methods are particularly suitable for glass fibers, which are generally resistant to melting and chemical dissolution. In other cases, however, the void fraction may be indirectly calculated based on the densities of the polymer, fibers, and tape in accordance with ASTM D 2734-16, where the densities may be determined ASTM D792-17. Of course, the void fraction can also be estimated using conventional microscopy equipment.

C. Optional Components

A wide variety of additional additives can also be included in the polymer composition, such as flow modifiers, pigments, antioxidants, stabilizers, antistatic agents, surfactants, waxes, flame retardants, anti-drip additives, and other materials added to enhance properties and processability.

### II. Three-Dimensional Printing

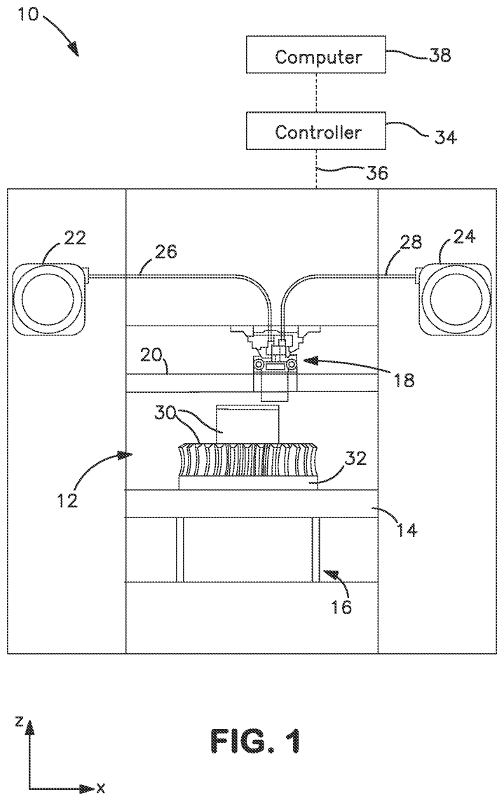

As noted above, the unique properties of the polymer composition are particularly well-suited for forming structures by three-dimensional printing. Various types of three-dimensional printing techniques may be employed, such as extrusion-based systems (e.g., fused deposition modeling). When employed in a fused deposition modeling system, for instance, the polymer composition may be employed as the build material that forms the three-dimensional structure and/or the support material that is removed from the three-dimensional structure after it is formed. Referring to FIG. 1, for example, one embodiment of a three-dimensional printing extruder system 10 is shown that may be employed to selectively form a precursor object containing a three-dimensional build structure 30 and a corresponding support structure 32. In the particular embodiment illustrated, the system includes a build chamber 12 and supply sources 22 and 24. As noted above, the polymer composition of the present invention may be used to form the build structure 30 and/or support structure 32. In those embodiments in which the polymer composition is only employed in the build structure or the support structure, it should be understood any other conventional material can be employed for the other structure. For example, in certain embodiments, the polymer composition of the present invention may be used to form the build structure 30. In such embodiments, suitable materials for the support structure 32 may include conventional materials that are soluble or at least partially soluble in water and/or an aqueous alkaline solution, which is suitable for removing support structure 32 in a convenient manner without damaging build structure 24. Examples of such materials may include those described in U.S. Pat. No. 6,070,107 to Lombardi et al., U.S. Pat. No. 6,228,923 to Lombardi et al., U.S. Pat. No. 6,790,403 to Priedeman et al., and U.S. Pat. No. 7,754,807 to Priedeman et al.

The material for the build structure 30 may be supplied to an extruder nozzle 18 from the supply source 22 via a feed line 26 and the support material for the support structure 32 may be supplied to the nozzle 18 from supply source 24 via a feed line 28. The build chamber 12 likewise contains a substrate 14 and substrate frame 16. The substrate 14 is a platform on which the build structure 30 and support structure 32 are built. The substrate is supported by a substrate frame 16, which is configured to move the substrate 14 along (or substantially along) a vertical z-axis. Likewise, the nozzle 18 is supported by a head frame 20, which is configured to move the nozzle 18 in (or substantially in) a horizontal x-y plane above chamber 12. The nozzle 18 is configured for printing the build structure 30 and the support structure 32 on the substrate 14 in a layer-by-layer manner, based on signals provided from the controller 34. In the embodiment shown in FIG. 1, for example, the nozzle 18 is a dual-tip extrusion nozzle configured to deposit build and support materials from the supply source 22 and the supply source 24, respectively. Examples of such extrusion nozzles are described in more detail in U.S. Pat. No. 5,503,785 to Crump, et al.; U.S. Pat. No. 6,004,124 to Swanson, et al.; U.S. Pat. No. 7,604,470 to LaBossiere, et al., and U.S. Pat. No. 7,625,200 to Leavitt. The system 10 may also include other print nozzles for depositing build and/or support materials from one or more tips. During a print operation, the frame 16 moves the nozzle 18 in the horizontal x-y plane within the build chamber 12, and drive mechanisms are directed to intermittently feed the build and support materials from supply sources 22 and 24. In alternative embodiments, the nozzle 18 may function as a screw pump, such as described in U.S. Pat. No. 5,764,521 to Batchelder, et al. and U.S. Pat. No. 7,891,964 to Skubic, et al.

The system 10 may also include a controller 34, which may include one or more control circuits configured to monitor and operate the components of the system 10. For example, one or more of the control functions performed by controller 34 can be implemented in hardware, software, firmware, and the like, or a combination thereof. The controller 34 may communicate over communication line 36 with chamber 12 (e.g., with a heating unit for chamber 12), the nozzle 18, and various sensors, calibration devices, display devices, and/or user input devices. The system 12 and/or controller 34 may also communicate with a computer 38, which is one or more computer-based systems that communicates with the system 12 and/or controller 34, and may be separate from system 12, or alternatively may be an internal component of system 12. The computer 38 includes computer-based hardware, such as data storage devices, processors, memory modules, and the like for generating and storing tool path and related printing instructions. The computer 38 may transmit these instructions to the system 10 (e.g., to controller 34) to perform printing operations so that the three-dimensional structure are selectively formed.

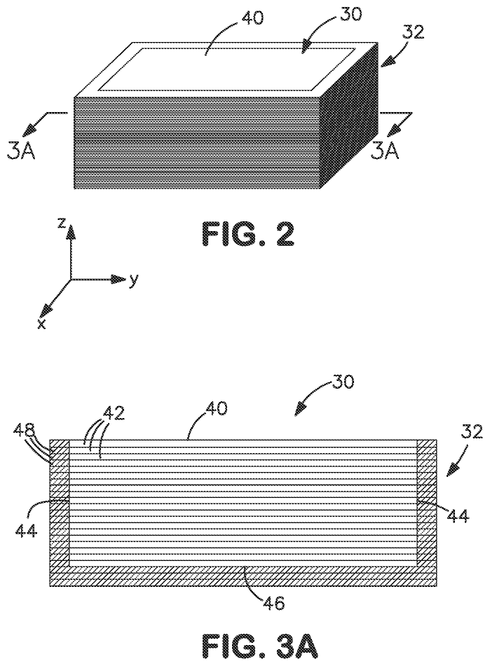

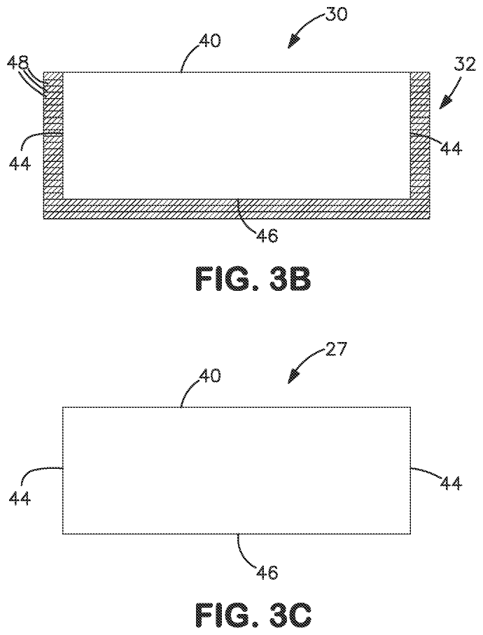

As shown in FIG. 2, the build structure 30 may be printed onto the substrate 14 as a series of successive layers of the build material, and the support structure 32 may likewise be printed as a series of successive layers in coordination with the printing of the build structure 30. In the illustrated embodiment, the build structure 30 is shown as a simple block-shaped object having a top surface 40, four lateral surfaces 44 (FIG. 3A), and a bottom surface 46 (FIG. 3A). Although by no means required, the support structure 32 in this embodiment is deposited to at least partially encapsulate the layers of build structure 30. For example, the support structure 32 may be printed to encapsulate the lateral surfaces and the bottom surface of build structure 30. Of course, in alternative embodiments, the system 10 may print three-dimensional objects having a variety of different geometries. In such embodiments, the system 10 may also print corresponding support structures, which optionally, at least partially encapsulate the three-dimensional objects.

FIGS. 3A-3C illustrate the process of for printing the three-dimensional build structure 24 and support structure 32 in the manner described above. As shown in FIG. 3A, each layer of the build structure 30 is printed in a series of layers 42 to define the geometry of the build structure 30. In this embodiment, each layer of the support structure 32 is printed in a series of layers 48 in coordination with the printing of layers 42 of the three-dimensional build structure 30, where the printed layers 48 of the support structure 32 encapsulate the lateral surfaces 44 and the bottom surface 46 of the build structure 30. In the illustrated embodiment, the top surface 40 is not encapsulated by the layers 48 of the support structure 32. After the print operation is complete, the support structure 32 may be removed from the build structure 30 to create a three-dimensional object 27. For example, in embodiments in which the support material is at least partially soluble in water or an aqueous alkaline solution, the resulting object may be immersed in water and/or an aqueous alkaline solution bath to dissolve the support structure 32.

The polymer composition may be supplied to the three-dimensional printer in a variety of different forms, such as in the form of a tape, sheet, filament, pellet, etc. In one particular embodiment, such as when a fused deposition modeling technique is employed, the polymer composition may be supplied in the form of a filament as described in U.S. Pat. No. 6,923,634 to Swanson, et al. and U.S. Pat. No. 7,122,246 to Comb, et al. The filament may, for example, have an average diameter of from about 0.1 to about 20 millimeters, in some embodiments from about 0.5 to about 10 millimeters, and in some embodiments, from about 1 to about 5 millimeters. The filament may be included within a printer cartridge that is readily adapted for incorporation into the printer system. The printer cartridge may, for example, contains a spool or other similar device that carries the filament. For example, the spool may have a generally cylindrical rim about which the filament is wound. The spool may likewise define a bore or spindle that allows it to be readily mounted to the printer during use.

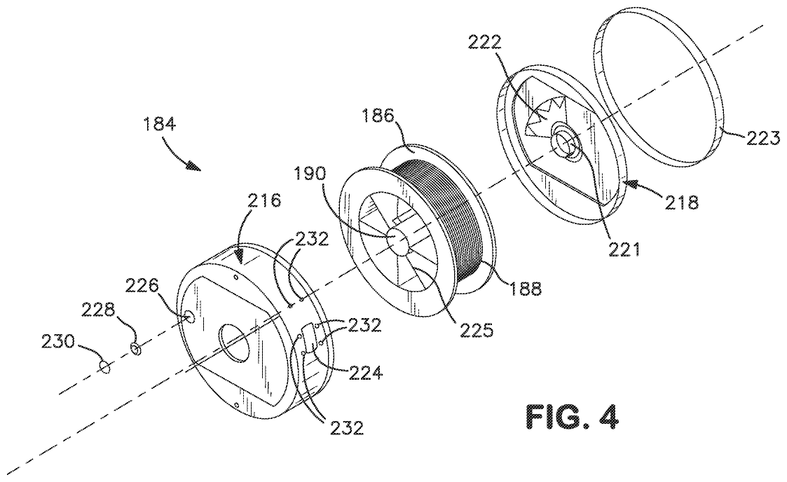

Referring to FIG. 4, for example, one embodiment of a spool 186 is shown that contains an outer rim about which a filament 188 is wound. A generally cylindrical bore 190 is also defined within a central region of the spool 186 about which multiple spokes 225 are axially positioned. Although not required, the printer cartridge may also contain a housing structure that encloses the spool and thus protects the filaments from the exterior environment prior to use. In FIG. 4, for instance, one embodiment of such a cartridge 184 is shown that contains a canister body 216 and a lid 218 that are mated together to define an interior chamber for enclosing the spool 186. In this embodiment, the lid 218 contains a first spindle 227 and the canister body 216 contains a second spindle (not shown). The spool 186 may be positioned so that the spindles of the canister body and/or lid are positioned within the bore 190. Among other things, this can allow the spool 186 to rotate during use. A spring plate 222 may also be attached to the inside of the lid 218 that has spiked fingers, which are bent to further enhance rotation of the spool 186 in only the direction that will advance filament out of the cartridge 184. Although not shown, a guide block may be attached to the canister body 216 at an outlet 224 to provide an exit path for the filament 188 to the printer system. The guide block may be fastened to the canister body 216 by a set of screws (not shown) that can extend through holes 232. If desired, the cartridge 184 may be sealed prior to use to help minimize the presence of moisture. For example, a moisture-impermeable material 223 (e.g., tape) may be employed to help seal the lid 218 to the canister body 216. Moisture can be withdrawn from the interior chamber of the canister body 216 through a hole 226, which can thereafter be sealed with a plug 228. A moisture-impermeable material 230 may also be positioned over the plug 228 to further seal the hole 226. Before sealing the cartridge 184, it may be dried to achieve the desired moisture content. For example, the cartridge 184 may be dried in an oven under vacuum conditions. Likewise, a desiccant material may also be placed within the cartridge 184, such as within compartments defined by the spokes 225 of the spool 186. Once fully assembled, the cartridge 184 may optionally be sealed within a moisture-impermeable package.

In addition to being supplied in the form of a filament, the polymer composition may also be supplied to the fused deposition modeling system of FIG. 1 in other forms. In one embodiment, for instance, the polymer composition may be supplied in the form of a tape. The tape may be provided in a printer cartridge, such as described above. In another embodiment, the polymer composition may be supplied in the form of pellets. When employed, for instance, the pellets may be supplied via a hopper (not shown) to a viscosity pump (not shown) that deposits the polymer composition onto the substrate 14. Such techniques are described, for instance, in U.S. Pat. No. 8,955,558 to Bosveld, et al., which is incorporated herein by reference. The viscosity pump may be an auger-based pump or extruder configured to shear and drive successive portions of received pellets and may be supported by a head frame 20 that can move the viscosity pump and/or hopper in the horizontal x-y plane.

The following test methods may be employed to determine certain of the properties described herein.

### Test Methods

Melt Flow Index: The melt flow index of a polymer or polymer composition may be determined in accordance with ISO 1133-1:2011 (technically equivalent to ASTM D1238-13) at a load of 2.16 kg and temperature of 230° C.

Volatile Organic Content (“VOC”): The total volatile organic content may be determined in accordance with an automotive industry standard test known as VDA 277:1995. In this test, for instance, a gas chromatography (GC) device may be employed with a WCOT-capillary column (wax type) of 0.25 mm inner diameter and 30 m length. The GC settings may be as follows: 3 minutes isothermal at 50° C., heat up to 200° C. at 12 K/min, 4 minutes isothermal at 200° C., injection-temperature of 200° C., detection-temperature of 250° C., carrier is helium, flow-mode split of 1:20 and average carrier-speed of 22-27 cm/s. A flame ionization detector (“FID”) may be employed to determine the total volatile content and a mass spectrometry (“MS”) detector may also be optionally employed to determine single volatile components. After testing, the VOC amount is calculated by dividing the amount of volatiles (micrograms of carbon equivalents) by the weight (grams) of the composition.

Toluene Volatile Organic Content (“TVOC”): The toluene-equivalent volatile organic content may be determined in accordance with an automotive industry standard test known as VDA 278:2002. More particularly, measurements may be made on a sample using a thermaldesoprtion analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 90° C.; final time of 30 min, and rate of 60 K/min. The cooling trap may be purged with a flow-mode split of 1:30 in a temperature range from −150° C. to +280° C. with a heating rate of 12 K/sec and a final time of 5 min. For analysis, the gas chromatography (“GC”) settings may be 2 min isothermal at 40° C., heating at 3 K/min up to 92° C., then at 5 K/min up to 160° C., and then at 10 K/min up to 280° C., 10 minutes isothermal, and flow of 1.3 ml/min. After testing, the TVOC amount is calculated by dividing the amount of volatiles (micrograms of toluene equivalents) by the weight (grams) of the composition.

Fogging Content (“FOG”): The fogging content may be determined in accordance with an automotive industry standard test known as VDA 278:2002. More particularly, measurements may be made on a sample using a thermaldesoprtion analyzer (“TDSA”), such as supplied by Gerstel using helium 5.0 as carrier gas and a column HP Ultra 2 of 50 m length and 0.32 mm diameter and 0.52 μm coating of 5% phenylmethylsiloxane. The analysis may, for example, be performed using device setting 1 and the following parameters: flow mode of splitless, final temperature of 120° C.; final time of 60 min, and rate of 60 K/min. The cooling trap may be purged with a flow-mode split of 1:30 in a temperature range from −150° C. to +280° C. with a heating rate of 12 K/sec. For analysis, the gas chromatography (“GC”) settings may be 2 min isothermal at 50° C., heating at 25 K/min up to 160° C., then at 10 K/min up to 280° C., 30 minutes isothermal, and flow of 1.3 ml/min. After testing, the FOG amount is calculated by dividing the amount of volatiles (micrograms of hexadecane equivalents) by the weight (grams) of the composition.

Tensile Modulus, Tensile Stress, and Tensile Elongation at Break: Tensile properties may be tested according to ISO Test No. 527-1:2012 (technically equivalent to ASTM D638-14). Modulus and strength measurements may be made on a dogbone-shaped test strip sample having a length of 170/190 mm, thickness of 4 mm, and width of 10 mm. The testing temperature may be −30° C., 23° C., or 80° C. and the testing speeds may be 1 or 5 mm/min.

Flexural Modulus, Flexural Elongation at Break, and Flexural Stress: Flexural properties may be tested according to ISO Test No. 178:2010 (technically equivalent to ASTM D790-15e2). This test may be performed on a 64 mm support span. Tests may be run on the center portions of uncut ISO 3167 multi-purpose bars. The testing temperature may be −30° C., 23° C., or 80° C. and the testing speed may be 2 mm/min.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A three-dimensional printing method comprising
supplying a polymer composition to an extruder system, wherein the polymer composition comprises a plurality of reinforcing fibers embedded and distributed within a thermoplastic polymer matrix, wherein the thermoplastic polymer matrix constitutes from about 20 wt. % to about 90 wt. % of the composition and the reinforcing fibers constitute from about 10 wt. % to about 80 wt. % of the composition;
selectively dispensing the polymer composition through an extruder nozzle of the system to form a three-dimensional structure.

2. The method of claim 1, wherein the reinforcing fibers are long fibers.

3. The method of claim 1, wherein the reinforcing fibers are continuous fibers.

4. The method of claim 1, wherein the polymer composition is in the form of a pellet.

5. The method of claim 1, wherein the polymer composition is in the form of a filament.

6. The method of claim 1, wherein the polymer composition is in the form of a tape.

7. The method of claim 1, wherein the tape has an upper outer surface and an opposing lower outer surface, and further wherein an upper region is defined adjacent to the upper outer surface, a lower region is defined adjacent to the lower outer surface, and a central region is defined between the upper region and the lower region, wherein the central region is fiber-rich and the upper and/or lower regions are polymer-rich.

8. The method of claim 1, wherein the polymer composition is formed by a process that includes pulling the reinforcing fibers through an impregnation die for contact with the thermoplastic polymer matrix.

9. The method of claim 1, wherein the polymer composition has a void content of about 5% or less.

10. The method of claim 1, wherein the reinforcing fibers include glass fibers, carbon fibers, or a combination thereof.

11. The method of claim 1, wherein the thermoplastic polymer matrix includes a thermoplastic aliphatic polymer.

12. The method of claim 11, wherein the thermoplastic aliphatic polymer includes a polyolefin, polyamide, polyurethane, polyacetal, or a combination thereof.

13. The method of claim 1, wherein the thermoplastic polymer matrix includes a thermoplastic aromatic polymer.

14. The method of claim 13, wherein the thermoplastic aromatic polymer includes a polyamide, polyurethane, polyarylene sulfide, polyarylether ketone, polyester, or a combination thereof.

15. A printer cartridge for use in a three-dimensional printing system, the printer cartridge comprising a filament that is formed from a polymer composition, wherein the polymer composition comprises a plurality of reinforcing fibers embedded and distributed within a thermoplastic polymer matrix, wherein the thermoplastic polymer matrix constitutes from about 20 wt. % to about 90 wt. % of the composition and the reinforcing fibers constitute from about 10 wt. % to about 80 wt. % of the composition.

16. The printer cartridge of claim 16, wherein the filament is wound around a rim of a spool.

17. A three-dimensional printing system comprising:
a supply source containing a polymer composition, wherein the polymer composition comprises a plurality of reinforcing fibers embedded and distributed within a thermoplastic polymer matrix, wherein the thermoplastic polymer matrix constitutes from about 20 wt. % to about 90 wt. % of the composition and the reinforcing fibers constitute from about 10 wt. % to about 80 wt. % of the composition; and
an extruder nozzle that is configured to receive the polymer composition from the supply source and deposit the composition onto a substrate.

18. The system of claim 17, wherein the supply source is a printer cartridge containing a filament, wherein the filament comprises the polymer composition.

19. The system of claim 17, wherein the supply source is a hopper containing pellets, wherein the pellets comprise the polymer composition.

20. The system of claim 19, further comprising a viscosity pump that contains the nozzle, wherein the viscosity pump is configured to receive the pellets from the hopper and extrude the pellets through the nozzle onto the substrate.

21. The system of claim 17, wherein the supply source is a printer cartridge containing a tape, wherein the tape comprises the polymer composition.
